(19) United States
(12) Patent Application Publication
(10) Pub. No.: US 2010/0245626 A1
(43) Pub. Date: Sep. 30, 2010

(54) Digital Camera

(76) Inventor: David Brian Woycechowsky, Syracuse, NY (US)

Correspondence Address: David B. Woycechowsky, 221 Whittier Avenue, Syracuse, NY, 13204, US

(21) Appl. No.: 12/413,635

(22) Filed: Mar. 30, 2009

(51) Int. Cl. H04N 5/76

(52) U.S. Cl. 348/231.7; 348/E05.031

(57) ABSTRACT

A digital camera with multiple ports for emovable memory cards. In some preferred embodiments, the multiple ports will be structured to hand the same type(s) of memory cards. In other preferred embodiments, the ports (or at least some of them) will be differently structured to handle different types of memory cards. In some preferred embodiment, any av files transferred to a memory card will be transferred to all ports having a memory card present. In other preferred embodiments, different av files will be transferred to different ports (or subsets of ports), depending on factors such as pre-programming and/or user selected preferences.

### BACKGROUND OF THE INVENTION

1. Field of the Invention

The present invention relates to digital cameras and more particularly to digital cameras including port(s) for removable memory card(s) (see DEFINITIONS section).

2. Description of the Related Art

Digital cameras with a port for storing digital video, audio and/or still image data from the camera are conventional. FIGS. 1 to 4 show a conventional digital camera system 100 including: microphone 102; lens assembly 104; user interface 106; memory card port P1 108; removable memory card 120; internal read only memory (ROM) 111; internal random access memory (RAM) 112 and control module 130. The user interface includes: buttons-dials-display assembly 106a and record button 106b. Control module 130 includes: audio-visual (av) data input sub-module 131; user interface sub-module 132; ROM communication sub-module 133; RAM communication sub-module 134; and single port writing sub-module.

In operation, a user uses interface 106 to cause the camera to record audio-visual data, such as sound, still images, video without sound (for example, time lapse video), or video with sound. Control module 130 performs appropriate collection and/or processing of the input data (for example, digital data) and causes the data to be saved as an appropriate type of av digital data file in RAM 112 and/or a removable memory card 120 which is removably inserted into P1 108. The user may also direct av digital data files to be moved or copied between RAM 112 and removable memory card port P1 108. In some conventional cameras, there is also a port structured to receive a data cable so that av digital data files can be transferred to and from/or the digital data cable port through control module to and/or from RAM 112 and/or memory card 120. For example, the cable may be used to transfer av digital files from RAM 112 to a personal computer (PC). In some conventional cameras, port 108 can receive and data communicate with different types of memory cards, such as some or all of the following memory card types: PC card (PCMCIA), CompactFlash, SmartMedia, Miniature Card, SD/MMC, Memory Stick, and/or xD-Picture Card.

### BRIEF SUMMARY OF THE INVENTION

The present invention is directed to a digital camera with multiple ports for emovable memory cards. In some preferred embodiments, the multiple ports will be structured to hand the same type(s) of memory cards. In other preferred embodiments, the ports (or at least some of them) will be differently structured to handle different types of memory cards. In some preferred embodiment, any av files transferred to a memory card will be transferred to all ports having a memory card present. In other preferred embodiments, different av files will be transferred to different ports (or subsets of ports), depending on factors such as pre-programming and/or user selected preferences.

Various embodiments of the present invention may exhibit one or more of the following objects, features and/or advantages:

(i) allow multiple memory cards to be distributed among multiple users of the camera (for example, pictures taken at a family reunion could be distributed to multiple family members before they head home from the reunion);

(ii) allows use of multiple types of memory cards;

(iv) allows different types of av digital data files (for example sound type files, still image type files; video with sound files, video without sound files) to be easily distributed as desired between and among different memory cards; and/or

(v) different av digital data files to be easily distributed as desired between and among different memory cards based on factors such as affirmative user choice, file size, file type, remaining card capacity, random distribution, distribution based on detected file content, etc.

### BRIEF DESCRIPTION OF THE DRAWINGS

The present invention will be more fully understood and appreciated by reading the following Detailed Description in conjunction with the accompanying drawings, in which:

FIG. 1 is an orthographic front view of a prior art digital camera;

FIG. 2 is an orthographic side view of the FIG. 1 digital camera;

FIG. 3 is an orthographic rear view of the FIG. 1 digital camera;

FIG. 4 is a schematic view of the FIG. 1 digital camera;

FIG. 5 is an orthographic front view of an embodiment of a digital camera according to the present invention;

FIG. 6 is an orthographic side view of the first embodiment camera;

FIG. 7 is an orthographic rear view of the first embodiment camera;

FIG. 8 is a schematic view of the first embodiment digital camera;

FIG. 9 is an orthographic front view of a second embodiment of a digital camera according to the present invention;

FIG. 10 is an orthographic side view of the second embodiment camera;

FIG. 11 is an orthographic rear view of the second embodiment camera;

FIG. 12 is a schematic view of the second embodiment digital camera;

FIG. 13 is an orthographic front view of a third embodiment of a digital camera according to the present invention;

FIG. 14 is an orthographic side view of the third embodiment camera;

FIG. 15 is an orthographic rear view of the third embodiment camera; and

FIG. 16 is a schematic view of the third embodiment digital camera.

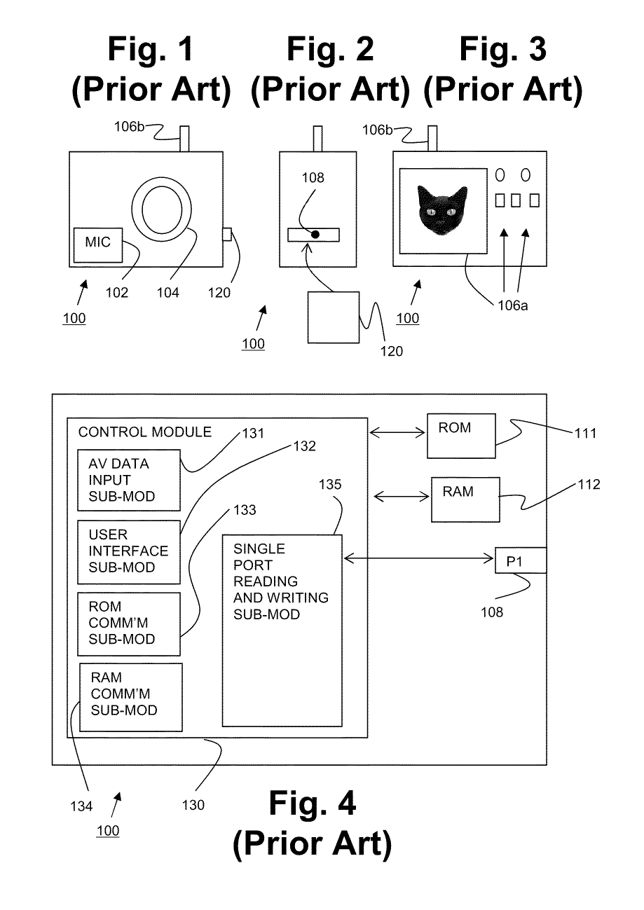

### DETAILED DESCRIPTION OF THE INVENTION

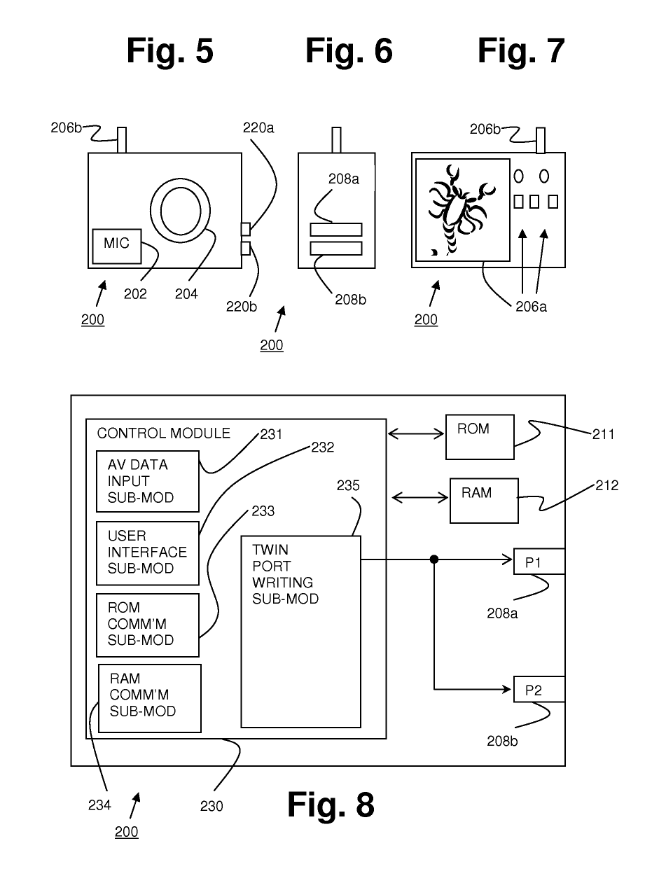

FIGS. 5 to 8 show a digital camera 200 according to the present invention, the camera including: microphone 202; lens assembly 204; user interface 206; memory card port P1 208a; memory card port P2 208b; internal read only memory (ROM) 211; internal random access memory (RAM) 212; removable memory cards 220a,b; and control module 230. The user interface includes: buttons-dials-display assembly 206a; and record button 206b. Control module 230 includes: audio-visual (av) data input sub-module 231; user interface sub-module 232; ROM communication sub-module 233; RAM communication sub-module 234; and twin port writing sub-module 235. Each of the memory card ports can accept multiple types of memory cards, but some variations of this embodiment could have ports that accept only a single type of memory card.

This camera operates in a similar manner to camera system 100, except that two removable memory cards can be inserted at the same time, and that any av file data that is to be written to a memory card(s) will be written to both cards (as long as both cards are present. This means that the memory cards, which are small in size and easy to carry, can be distributed among multiple users of the camera who do not want the hassle of sharing pictures by email or other similar means. Each person simply gets their own card to take home. Also, two different types of memory cards can be inserted so that the cards can be used as appropriate with other devices (for example, card readers) that may require a certain type of card. For example, if a user has a printer that accepts only SD cards, and a digital picture frame that accepts only Memory Stick cards, then the user can use the same files on both of her devices without intermediate data transfers between card types.

If one of the cards is not present or has a full memory then this could be handled either by writing to whatever card is available and ready, and not the other, or it could refuse the av data file transfer in its totality, as if there were only a sing card port with a not-present or full memory card. As a further variation, more memory card ports could be provided—for a family reunion it would be handy to have as many ports as there are households represented at the reunion, for example. The multiple memory card ports do not all need to be physically located next to each other as ports 208b and 208c are. For example, one of the ports may be located behind a lockable access port and the other may be located on the outer surface of the camera for easy access.

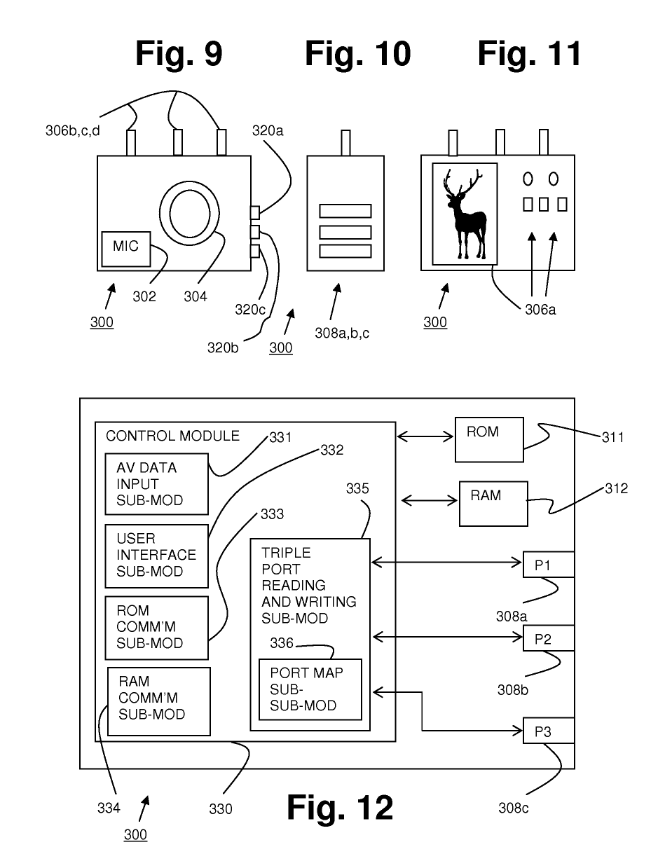

FIGS. 9 to 12 show a digital camera 300 according to the present invention, the camera including: microphone 302; lens assembly 304; user interface 306; memory card port PI 308a; memory card port P2 308b; memory card port P3 308c; internal read only memory (ROM) 311; internal random access memory (RAM) 312; removable memory cards 320a,b,c; and control module 330. The user interface includes: buttons-dials-display assembly 206a; and record buttons 206b,c,d. Control module 330 includes: audio-visual (av) data input sub-module 331; user interface sub-module 332; ROM communication sub-module 333; RAM communication sub-module 334; and triple port reading and writing sub-module 335.

Camera 300 can separately write av files to each of the three removable memory card ports P1, P2, P3. More specifically, in camera 300: (i) the operation of record button 306b, by a user, will record the recorded av data file to the card in port P1; (i) the operation of record button 306c, by a user, will record the recorded av data file to the card in port P2; and (iii) the operation of record button 306d, by a user, will record the recorded av data file to the card in port P3. Alternatives, the choice of which removable memory card ports will be written with which recorded av data files may be determined in other ways, as explained in more detail below. However, having a separate button for each card may be preferred for cameras that are designed to be simple to use with minimal and intuitive interaction with the user interface. For example, if all three users wanted a still image, then buttons 306b,c,d could be depressed simultaneously or in quick succession as a simple way of getting substantially the same still image on every card at once without the necessity of communicating preferences through a menu driven user interface. As a further variation, instead of three record buttons, multiple taps and/or different duration taps on a single record button could be used as a sort of code for determining which removable memory card(s) are to be written to.

Regardless of exactly how the choice of which ports P1, P2 and/or P3 are to be written with a given av file, the port mapping sub-sub-module of triple port reading and writing sub-module controls the writing operation so that the av file gets to the correct removable memory card port(s), and only the correct removable memory card port(s). Because the triple port reading and writing module 335 is a reading and writing module, it can also receive AV data files, or other data, from removable memory cards in each of the ports P1, P2, P3. For example, the memory card itself could be written with storage preference data specifying preferences for which av data files should preferably written to that particular memory card. For example, a card may specify that it is to receive only av data files corresponding to still images taken with low light camera settings.

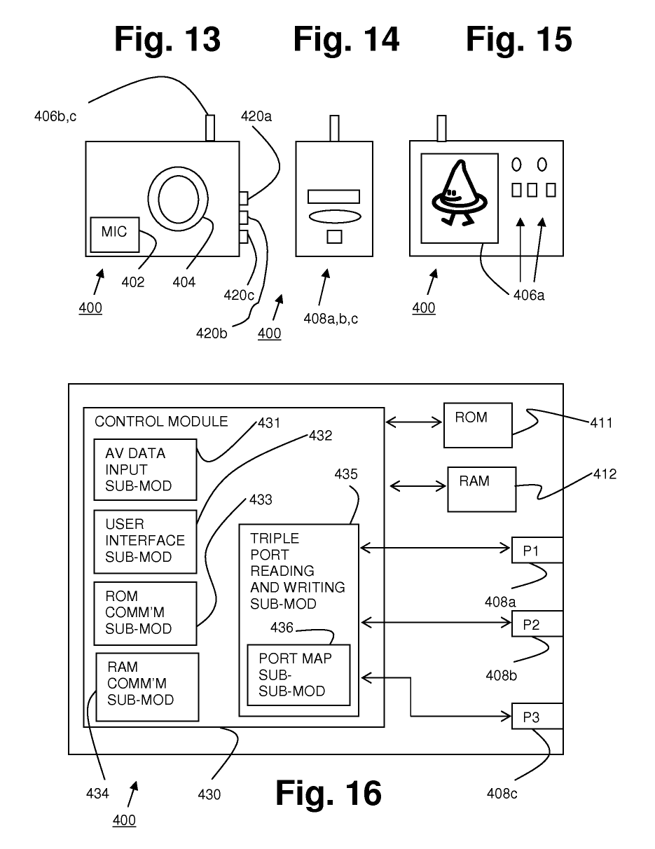

FIGS. 13 to 16 show a digital camera 400 according to the present invention, the camera including: microphone 402; lens assembly 404; user interface 406; memory card port P1 408a; memory card port P2 408b; memory card port P3 408c; internal read only memory (ROM) 411; internal random access memory (RAM) 412; removable memory cards 420a,b,c; and control module 430. The user interface includes: buttons-dials-display assembly 406a; and record button 406b. Control module 430 includes: audio-visual (av) data input sub-module 431; user interface sub-module 432; ROM communication sub-module 433; RAM communication sub-module 434; and triple port reading and writing sub-module 435 (including port mapping sub-sub-module 436). As shown in FIG. 14, each of the removable memory card ports has a different shape and receives different type(s) of memory cards, although it is noted that the types may overlap somewhat.

In camera 436, the algorithm and/or rules for determining which av data files are written to which removable memory card ports is determined by port mapping sub-sub-module 436. For the most part, this algorithm and/or rules would be determined by inputs form ROM 411 (for pre-programmed rules, preferences, etc.) and/or user interface 406, 432. There is an infinitude of preferences, algorithms and rules that could be defined. Some of the factors that might be considered include the following: (i) data file type; (ii) memory card type; (iii) camera settings (for example, low light); (iv) file size; (v) time of day/day of the week/etc.; (vi) subject matter of the data (for example, images containing detected human faces go to certain pre-prescribed card(s)); (vii) random distribution; (viii) biometric data of the camera user (for example, voice detection for a voice activated camera); and/or (ix) file distribution based on remaining card capacities. Multiple factors may be used in the same algorithm. For example, sound av files might be recorded to the P1 card, unless they exceed a certain file size, in which case they go to P3. As a further example, video files might be sent to the P2 card, unless its remaining capacity is below a predetermined threshold.

### DEFINITIONS

The following definitions are provided to facilitate claim interpretation:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, force fit connections, friction fit connections, connections secured by engagement added by gravitational forces, quick-release connections, pivoting or rotatable connections, slidable mechanical connections, latches and/or magnetic connections).

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Removable memory card: any removable memory card now known, or to be developed in the future that can reside substantially within a removable memory card port of a camera; removable memory cards to do not include data cables and/or devices that are connected to cameras through data cables.

Removable memory card type: any type of removable memory card now known, or to be developed in the future; memory card types include, but are not limited to PC card (PCMCIA), CompactFlash, SmartMedia, Miniature Card, SD/MMC, Memory Stick, and/or xD-Picture Card; however, to the extent that a memory card type, such as a PCMCIA card, does not reside substantially within the camera frame, it is not considered to be a “removable memory card” as that term is used herein (see DEFINITION of “removable memory card”).

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A digital camera comprising:
a camera frame;
digital av file recording hardware mechanically connected to the camera frame;
a first removable memory card port mechanically connected to the camera frame and electrically connected to the digital av file recording hardware;
a second removable memory card port mechanically connected to the camera frame and electrically connected to the digital av file recording hardware;
wherein:
the digital av file recording hardware is structured and/or programmed to record at least one type of digital av file;
the first removable memory card port is structured and/or located to removably receive a first set of removable memory card type(s);
the second removable memory card port is structured and/or located to removably receive a second set of removable memory card type(s);
the digital av file recording hardware is electrically connected to the first removable memory card port so that it can write recorded av files to a removable memory card when present in the first removable memory card port through the first removable memory card port; and
the digital av file recording hardware is electrically connected to the second removable memory card port so that it can write recorded av files to a removable memory card when present in the second removable memory card port through the second removable memory card port.

2. The camera of claim 1 wherein the digital av recording file hardware comprises:
a video data recording module; and
a control module electrically connected to the video data recording module.

3. The camera of claim 1 wherein the digital av recording file hardware comprises:
an audio data recording module; and
a control module electrically connected to the audio data recording module.

4. The camera of claim 1 wherein the digital av recording file hardware comprises:
a video data recording module;
an audio data recording module; and
a control module electrically connected to the video data recording module and the audio data recording module.

5. The camera of claim 1 wherein the digital av recording file hardware comprises:
a still image data recording module; and
a control module electrically connected to the still image data recording module.

6. The camera of claim 1 wherein the camera frame is sized to be handheld.

7. The camera of claim 1 further comprising wireless telephone hardware, mechanically connected to the camera frame, the wireless telephone hardware being structured and/or programmed to provide wireless telecommunications.

8. The camera of claim 1 wherein the first removable memory card port and the second removable memory card port are each electrically connected to the digital av recording hardware so that:
any recorded av files sent to the first removable memory card port will also be sent to the second removable memory card port; and
any recorded av files sent to the second removable memory card port will also be sent to the first removable memory card port.

9. The camera of claim 1 wherein the first removable memory card port and the second removable memory card port are each electrically connected to the digital av recording hardware so that recorded av files may be sent to the first removable memory card port and the second removable memory card port independently.

10. A digital camera comprising:
a camera frame;
digital av file recording hardware mechanically connected to the camera frame, the digital av recording hardware comprising:
a video data recording module,
a still image recording module, and
a control module electrically connected to the video data recording module and the still image recording module;
a first removable memory card port mechanically connected to the camera frame and electrically connected to the digital av file recording hardware;
a second removable memory card port mechanically connected to the camera frame and electrically connected to the digital av file recording hardware;
wherein:
the digital av file recording hardware is structured and/or programmed to record at least one type of digital av file;
the first removable memory card port is structured and/or located to removably receive a first set of removable memory card type(s);
the second removable memory card port is structured and/or located to removably receive a second set of removable memory card type(s);
the digital av file recording hardware is electrically connected to the first removable memory card port so that it can write recorded av files to a removable memory card when present in the first removable memory card port through the first removable memory card port;
the digital av file recording hardware is electrically connected to the second removable memory card port so that it can write recorded av files to a removable memory card when present in the second removable memory card port through the second removable memory card port;
the first removable memory card port and the second removable memory card port are each electrically connected to the digital av recording hardware so that recorded av files may be sent to the first removable memory card port and the second removable memory card port independently; and
the control module comprises a port mapping sub-module structured and/or programmed to determine: (i) which recorded av files are sent to the first removable memory port, and (ii) which recorded av files are sent to the second removable memory card port.

11. The camera of claim 10 wherein the port mapping sub-module is pre-programmed to determine: (i) which recorded av files are sent to the first removable memory port, and (ii) which recorded av files are sent to the second removable memory card port.

12. The camera of claim 10 further comprising user interface hardware structured and or programmed to receive user port preference data from a user and to send the user port preference data to the port mapping sub-module, wherein the port mapping sub-module is further structured and/or programmed to use the user port preference data in determining: (i) which recorded av files are sent to the first removable memory port, and (ii) which recorded av files are sent to the second removable memory card port.

13. A digital camera comprising:
a camera frame;
a first removable memory card port mechanically connected to the camera frame;
a second removable memory card port mechanically connected to the camera frame;
a first removable memory card removably inserted in the first removable memory card port; and
a second removable memory card removably inserted in the second removable memory card port.

14. The camera of claim 13 wherein the first removable memory card has a different storage capacity than the second removable memory card.

15. The camera of claim 13 wherein the first removable memory card is of a different removable memory card type than the second removable memory card.
